(19) United States
(12) Patent Application Publication
(10) Pub. No.: US 2026/0175468 A1
(43) Pub. Date: Jun. 25, 2026

(54) MANUFACTURING A WOOD COMPOSITE PANEL COMPRISING SOY

(71) Applicant: Lignum Technologies AG, Niederteufen (CH)

(72) Inventors: Christian Felipe SCHWEITZER, Shippenville, PA (US); Justin Russell HEIM, Seneca, PA (US)

(73) Assignee: Lignum Technologies AG, Niederteufen (CH)

(21) Appl. No.: 19/128,756

(22) PCT Filed: Nov. 11, 2022
(86) PCT No.: PCT/EP2022/081576

§ 371 Date: May 9, 2025

(51) Int. Cl. B27N 1/02; B27N 3/00; B27N 3/04; B27N 3/12; B27N 3/20

(52) U.S. Cl. CPC B27N 1/0209; B27N 3/002; B27N 3/04; B27N 3/12; B27N 3/203

(57) ABSTRACT

A method for manufacturing a wood composite panel, in particular an MDF-panel, comprises the following steps: a. providing and mixing soy flour and water in a weight ratio of about 10 to 45% to form a soy solution; b. introducing the soy solution to a high-pressure blow line containing wood fibers; c. introducing resin to the high-pressure blow line to form a soy solution wood fiber resin mixture; d. pre-drying the soy solution wood fiber resin mixture to form a pre-dried soy flour wood fiber resin mixture; and e. hot-pressing the pre-dried soy flour wood fiber resin mixture into the wood composite panel.

### 1. FIELD OF THE INVENTION

The invention relates to a method for manufacturing a wood composite panel comprising soy, a wood composite panel comprising soy and a respective system for manufacturing a wood composite panel comprising soy.

### 2. BACKGROUND

Many different wood composite boards or panels, in particular so-called medium density wood fiber boards (MDF-boards) or high-density fiber boards (HDF-boards), are known in the state of the art. For manufacturing said panels, commonly wood particles or fibers and a suitable binder such as a resin are mixed and pressed to form resulting wood composite panels. Such panels serve, for example, as a basic element or carrier plate to produce furniture or floor coverings. Since resins can be quite expensive and are usually made of non-environmentally friendly chemicals, several attempts have been made in the art to employ different alternative materials, which, at least partly, allow to substitute resin in wood composite panels. Promising approaches have been made employing soy as a substitute means for the resin, which is a cheap and quickly renewable material. However, when employing soy as a substitute material, difficulties remain with respect to quality and durability of the resulting panels, such as physical and chemical resistivity, compared to panels made with resin only.

It is therefore an object of the present invention to provide a cheap and environmentally friendly alternative of manufacturing wood composite panels, while achieving a high quality of the produced panels.

### 3. DETAILED DESCRIPTION OF THE INVENTION

The above noted problems are at least partially solved by a method for manufacturing a wood composite panel according to claim 1, a corresponding wood composite panel according to claim 11 and a respective system for manufacturing a wood composite panel according to claim 15.

Particularly, the present invention relates to a method for manufacturing a wood composite panel, in particular an MDF-panel, comprising the following steps: a. providing and mixing soy flour and water in a weight ratio of about 10 to 45% to form a soy solution; b. introducing the soy solution to a high-pressure blow line containing wood fibers; and c. introducing resin to the high-pressure blow line to form a soy solution wood fiber resin mixture; d. pre-drying the soy solution wood fiber resin mixture to form a pre-dried soy flour wood fiber resin mixture; e. hot-pressing the pre-dried soy flour wood fiber resin mixture into the wood composite panel.

Thus, a durable and cheap wood composite panel can be obtained, which, on the one hand, substitutes a significant amount of resin with soy flour and, on the other hand, provides a high quality such as a good physical resistivity. The method of the present invention provides very well homogenized mixtures of soy and water and very well homogenized mixtures of soy solution, wood fibers and resin, which could not be achieved by methods according to the prior art. The above steps a. to e. may be performed in a different order or preferably in the given order. The introduction of the resin to the high-pressure blow line may preferably occur downstream of the introduction of the soy solution to the high-pressure blow line, i.e. the resin is added after the soy solution is added to the wood fibers. Water may be supplied to the soy solution via a respective water regulation valve, which is adjustable to start or stop the flow of water supply, dependent on the amount of water needed to prepare a desired amount of soy solution. The water regulation valve may be accordingly closed after a sufficient amount of water has been provided.

The soy may be added to the water based on the amount of resin added in a later step and may have an addition rate of between about 5% to 20% by weight of soy solid over the total amount of resin. For example, if a 10% solid soy addition rate is desired by way of a 20% concentration soy solution (corresponding to 20 kg of soy added to 80 kg of water) and the addition resin flow is set to 1000 kg per hour, the solid soy addition may be 100 kg per hour. This would then be equivalent to 500 kg of soy solution at a 20% concentration.

In a preferred embodiment, soy flour and water are mixed in step a. in a weight ratio of about 12.5 to 35% and preferably in a weight ratio of about 15 to 30% to form a soy solution.

Thus, a mixture with a suitable viscosity may be obtained, which comprises a sufficient amount of soy and also enables a suitable processability. The mixing of soy flour and water may be adjusted according to the needs of the resulting panel to be manufactured. The term “weight ratio” should be understood such that, if for instance a mixture of 20% weight ratio should be obtained, 200 g of soy is for instance added to 1000 g water.

The soy flour may be preferably an unmodified soy flour. Hence, a cheap and easily accessible soy source can be used for manufacturing the wood composite panels according to the present invention.

The water supplied for mixing with the soy flour may have a temperature in a range of about 4 and 40° C., preferably about 7 to 35° C. and most preferably about 10 to 25° C. At that temperature range, mixing of soy flour and water may be facilitated. Below said temperatures, more time energy may be needed to dissolve the soy flour in the water. Above said temperatures, the soy-water mixture may have short shelf life (less than 2 hours) due to start of soy fermentation. Hence, the viscosity of the mixture potentially increases.

In a preferred embodiment, between steps d. and e., an additional step of forming the pre-dried soy flour wood fiber resin mixture into mats is provided, wherein the mats are then hot-pressed in the next step.

The thickness or height of the mats may be adjusted considering the subsequent pressing step to obtain a suitable final thickness of the resulting panel, thus allowing for a quick and proper pressing. The mat may be formed to have a thickness of about 25 to 500 mm, preferably about 50 to 350 mm. Furthermore, the mat may also be sized and shaped in length and/or width to obtain suitable dimensions of the resulting panels after pressing. Or the mat could be provided as a continuous mat, which results in an “infinite” panel after pressing, which then may be accordingly cut to the desired size.

In a preferred embodiment, the mixing in step a. comprises a recirculation step, wherein the soy solution is recirculated for about 2 to 180 minutes, preferably about 5 to 120 minutes and most preferably about 10 to 60 minutes to obtain a consistent soy solution.

Thus, a particular homogenous mixture can be obtained. The recirculation may be provided such that soy is continuously added during the recirculation process. Hence, enriching the soy solution with soy up to a desired soy concentration may be achieved. Alternatively, the soy may also be added to the soy solution just at the beginning of the recirculation process. The recirculation flow may be regulated via respective valves or shutters provided in the recirculation path. During recirculation soy may or may not be continuously added.

Before the recirculation step, a pre-recirculation step may be performed, in which pure water is recirculated without the addition of soy. This may allow preventing a plugging of elements through which the soy solution may flow during recirculation, such as any lines, valves, batches and/or mixers etc. The pre-recirculation step may be performed for about 0.1 to 10 minutes, preferably for about 0.5 to 5 minutes and most preferably for about 1 to 2 minutes.

In a preferred embodiment, the high-pressure blow line provides a pressure of about 0.2 to 0.8 MPa, preferably about 0.3 to 0.7 MPa and most preferably about 0.4 to 0.6 MPa and/or the high-pressure blow line provides a temperature of about 100° C. to 200° C., preferably about 130° C. to 180° C. and most preferably about 150° C. to 165° C.

Hence, the mixtures contained in high-pressure blow line may be pressurized and/or may have a particular increased temperature, thus allowing for a particular well mixing of the different compounds contained in the high-pressure blow line. The high-pressure blow line may comprise an outlet, from which the prepared mixture can be subsequently transferred further towards downstream system elements such as a dryer or a press.

In a preferred embodiment, the resin is a synthetic resin, preferably a PMDI resin.

Hence, a suitable binding of the wood fibers can be obtained. The present invention is, however, not limited to the above noted resins. Hence, also any other suitable type of resin common in the art may be used, such as Urea-Formaldehyde resins or phenolic resins etc.

The resin and/or the soy solution may be introduced to the high-pressure blow line with a pressure of 0.2 to 0.8 MPa, preferably MPa 0.3 to 0.7 and most preferably 0.4 to 0.6 MPa. Hence, a particular well mixing of the pressurized introduced resin and/or soy solution and the wood fibers contained in the high-pressure blow line may be achieved. Introduction or injection of the soy solution and the resin to the high-pressure blow line may be performed by respective suitable pumps and valves to allow establishing a respective pressure for introduction or injection of the compounds to the high-pressure blow line. The flow rate of resin may be adjusted depending on the thickness of the panel to be produced and may vary in a range of about 400 to 1600 L per hour, preferably about 600 to 1400 L per hour and more preferably about 800 to 1200 L per hour.

In a preferred embodiment, the soy solution wood resin mixture obtained in step c. has a moisture content of about 40 to 90%, preferably about 50 to 80% and most preferably about 70%.

Thus, the soy solution wood resin mixture may have a sufficient low viscosity for the further processing steps. It may, for instance, allow an easy pumping of the mixture to a remote location, before it is further processed.

In a preferred embodiment, the pre-dried soy flour wood fiber resin mixture obtained in step d. has a moisture content of about 5 to 30%, preferably about 7 to 20% and most preferably about 10%.

Thus, superfluous moisture, which may impair the subsequent pressing process may be reduced. The extent of pre-drying may be adapted to the parameters of the downstream press, e.g. based on the temperature employed during the pressing process. The pre-drying process may be performed for about 1 to 60 seconds, preferably about 3 to 30 seconds, further preferably about 4 to 20 seconds and most preferably about 5 to 6 seconds. The pre-drying time may depend on the moisture of the soy solution wood fiber resin mixture and may be accordingly adapted. Further, the drying process parameters, which may also include a suitable pre-drying temperature, may also be adapted considering the thickness of the panel or the amount of mixture to be dried.

In a preferred embodiment, the recirculation step and the soy solution injection step are performed simultaneously.

This may allow to reduce the panel manufacturing process time, since the soy solution preparation step and the step of injecting and mixing the soy solution with the wood fibers in the high-pressure blow line are carried out in parallel. The individual steps may be controlled in such a way that a new batch of soy solution is already prepared when the injection to the high-pressure blow line is completed. Hence, the new batch of solution could be immediately transferred.

The present invention further relates to a wood composite panel obtainable by the method according to one of the preceding claims, wherein the panel comprises at least about 0.1 to 3.0% by weight of soy, preferably about 0.2 to 1.2% by weight of soy and most preferably about 0.4 to 0.8% by weight of soy.

Hence, a durable and cheap wood-based composite panel comprising soy is obtained. The panel according to the present invention may of course also comprise any further suitable materials common in the art of manufacturing composite panels, such as additives, fillers and/or colorants.

According to an embodiment of the present invention, wood composite panels according to the present invention comprise the following physical properties:

TABLE 1
Physical properties of soy panel samples according to the present
invention and respective comparative control panels without soy

| | | | Face | Core | | | | | |
|---|---|---|---|---|---|---|---|---|---|
| | Thickness | Density | density | density | IB | MOR | MOE | TS | MC |
| | [cm] | [kg/m³] | [kg/m³] | [kg/m³] | [MPa] | [MPa] | [MPa] | [%] | [%] |
| Soy | 1.905 | 724.03 | 961.11 | 663.16 | 0.9377 | 42.1132 | 4950.4357 | 3.2 | 7.3 |
| sample #1 | | | | | | | | | |
| Soy | 1.905 | 722.43 | 959.51 | 658.36 | 0.9032 | 38.6382 | 4178.2229 | 3.6 | 6.5 |
| sample #2 | | | | | | | | | |
| Comparative | 1.905 | 728.84 | 957.90 | 663.16 | 0.8618 | 40.2102 | 4212.6967 | 3.5 | 7.1 |
| sample #1 | | | | | | | | | |
| Comparative | 1.905 | 733.65 | 973.92 | 669.57 | 0.7791 | 59.9017 | 6019.1231 | N/A | 5.9 |
| sample #2 | | | | | | | | | |

The above panel samples were obtained using a continuous press with a press speed of 10.82 m per second. In the above table, “Density” is the average density of the respective sample, “Face density” is the highest density of the panel sample, close to the surface of the respective sample and “Core density” is the minimum density of the panel sample, close to the center of the panel. The densities were measured across the thickness of each sample using an x-ray density measurement machine. “IB” is the “Internal bond strength”, which may be obtained by measuring the force that it takes to break apart in the thickness direction a 25 cm² sample using a dynamometer machine. “MOR” is the “Modulus of rupture”, which may be obtained by measuring the force that it takes to bend a breaking point of a 250 cm² sample using a dynamometer machine. “TS” is the “Thickness swell” and may be obtained by measuring the initial and final thickness of a 250 cm² panel sample before and after it has been submerged in water for 24 hours. “MC” is the “Moisture content” and may be obtained by measuring the initial and final weight of a 225 cm² panel sample that has been dried in an oven for 24 hours. As can be seen from the above Table 1, wood-based composite panels comprising soy can be obtained with physical properties that are equal or even improved to comparative wood-based composite panels without soy.

The present invention further relates to a system for manufacturing a wood composite panel, in particular an MDF-panel, wherein the system comprises: a mixing means for mixing water with soy flour powder to form a soy solution, a high-pressure blow line connected to the mixing means, comprising: a wood fiber port for introducing wood fibers to the high-pressure blow line, a soy solution port for introducing the soy solution to the high-pressure blow line, and a resin port for introducing resin to the high-pressure blow line to form a soy solution wood fiber resin mixture, wherein the system further comprises a dryer arranged downstream of the high-pressure blow line for pre-drying the soy solution wood resin mixture to obtain a pre-dried soy flour wood fiber resin mixture, and a press for hot-pressing the pre-dried soy flour wood fiber resin mixture to form the wood composite panel.

Hence, a system is provided, which allows to manufacture cheap and durable wood composite panels. The resin port may be preferably arranged downstream of the soy solution port, such that the resin is added after the soy solution has been added to the wood fibers in the high-pressure blow line. The blow line may comprise further ports for the introduction of further compounds, such as additives, fillers and/or colorants to be mixed to obtain the wood composite panel. The dryer may be any type of dryer allowing a suitable drying of the mixture, such as a hot gas air dryer or a pneumatic flash dryer comprising a dryer fan providing hot gas to dry the mixture. The press may be a continuous press, such as a belt press, but is not limited to this type of press. Hence, also any other suitable type of press for pressing the soy flour wood fiber resin mixture into panels, e.g. a plate press etc. may be used. If a continuous press is employed, the press may run at a speed of about 100 to 5000 mm per second, preferably about 270 to 2700 mm per second. Pressing times of about 0.1 to 30 minutes, preferably 0.5 to 15 minutes and most preferably about 1 to 7 minutes may be used. Suitable pressures applied by the press may be up to about 1500 N/mm², preferably up to about 1000 N/mm² and more preferably up to about 500 N/mm². The temperatures employed in the press may be from about 80° C. to 400° C., preferably from about 120° C. to 300° C. and more preferably from about 170° C. to 230° C.

In a preferred embodiment, the system further comprises a mat forming means for forming the pre-dried soy solution wood resin mixture into mats before pressing.

Hence, the pre-dried soy solution wood resin mixture may be brought into a suitable pre-defined shape and size before pressing. The mat forming means may include means for providing a suitable shape, including for instance means for setting a suitable height, length, and width of the mats, dependent on the desired size of the panel. The mixture may also be laid down on a continuous conveyor belt to form a mat of a distinct size and height. Hence, the mat forming means and the conveyor belt may be accordingly controlled with respect to each other such that a defined amount per time of pre-dried soy solution wood resin mixture may be laid down to the conveyor belt moving at a distinct speed. Furthermore, the processing times of the mat forming means, the conveyor belt and the press may be accordingly controlled with respect to each other to allow a continuous feed of one or mats to the press.

In a preferred embodiment, the mixing means comprises: a soy solution preparation tank having an inlet and an outlet, and a mixer, preferably a high shear mixer, comprising an inlet and an outlet, wherein the mixer inlet is connected to the soy solution preparation tank outlet to receive water or soy solution from the soy solution preparation tank, and wherein the mixer outlet is connected to the soy solution preparation tank inlet via a recirculation path to allow a recirculation of the water or soy solution.

Hence, a proper recirculation of the soy solution to be prepared may be obtained to allow a constant mixture of soy and water. The mixing means may be a single element or may contain a plurality of elements interconnected and working together to allow a proper mixing. In particular, the employment of a high shear mixer may allow for an improved mixing, thus reducing the effective time needed to obtain an evenly mixed soy solution. The preparation tank may be suitably dimensioned to allow storage of a proper amount of soy solution. The present invention is of course not limited to the provision of only one soy solution preparation tank or one mixer but may also comprise a plurality of respective soy solution preparation tanks or a plurality of mixers.

Furthermore, the system may comprise a three-way valve, which may be provided between the soy solution preparation tank and the soy solution feed tank for allowing a flow towards the soy solution feed tank or for allowing a recirculation back to the soy solution preparation tank. The three-way valve may be arrangeable in a state, wherein a flow from the soy solution preparation tank to the soy solution feed tank is allowed and wherein a recirculation back to the soy solution preparation tank is prevented. Or the three-way valve may be arrangeable in a different state, in which a flow from the soy solution preparation tank is prevented and a recirculation flow back to the soy solution preparation tank is allowed. Thus, a proper control of the fluid flows during the manufacturing process of wood composite panels according to the present invention could be obtained. The system of the present invention may of course be provided also with further or different fluid flow control means, such as different or further valves, if desired.

The system may further comprise a wood refiner, which can be supplied with any type of suitable wood chips, such as soft or hard wood. The wood chips may be supplied to the refiner via a wood chips supply path. Further, hot pressurized steam may be supplied to the refiner via a steam supply path. The supplied hot steam may be provided with an increased pressure for breaking up the wood chips into wood fibers, for instance in a range of about 0.3 to 1.5 MPa, preferably about 0.6 MPa to 1.0 MPa, most preferably about 0.8 MPa. To break up the wood chips into wood fibers of a suitable size, the refiner may be powered with a suitable amount of electricity, such as for instance about 25 to 250 kW per ton of chips, preferably about 50 to 200 kW, more preferably about 75 to 150 kW, most preferably about 100 kW. Breaking up the wood chips to fibers may take about 0.5 to 20 minutes, preferably about 2 to 10 minutes and more preferably about 3 to 5 minutes and may be performed at a temperature of about 80 to 300° C., preferably about 130 to 250° C. and most preferably about 160° C. and/or pressures of about 0.2 MPa to 1.5 MPa, preferably about 0.4 MPa to 1 MPa and most preferably about 0.6 MPa.

The system may further comprise a means for separating coarse particles, such as a cyclone separator, which may be used for instance to separate the solid contents of the pre-dried soy flour wood fiber resin mixture (i.e. wood fibers, resin, soy flour and any other solids) from a hot air stream provided by a dryer arranged upstream of the separator. The separation may take about 5 to 120 seconds, preferably about 10 to 60 seconds, and most preferably about 15 to 20 seconds.

In a preferred embodiment, the system further comprises a soy solution feed tank, which is adapted to receive the soy solution from the soy solution preparation tank, and which is further adapted to transmit the soy solution to the high-pressure blow line, preferably via a pump arranged between the soy solution feed tank and the high-pressure blow line.

The soy solution preparation tank may be filled with water up to a predetermined level for ensuring that a consistent concentration of soy may be obtained also across different batches, e.g. one or more consecutive batches of soy solution. The preparation of soy solution in the soy solution preparation tank may be performed at the same time as the soy solution feed tank feeds soy solution to the high-pressure blow line. This allows a time saving and increases productivity of the claimed system. It may accordingly allow to reduce or even completely prevent a downtime until a new batch of prepared soy solution can be injected to the high-pressure blow line.

The soy solution prepared in the soy solution preparation tank may be transferred to the soy solution feed tank before the soy solution feed tank is completely emptied. The transfer to the high-pressure blow line may be accordingly stopped and the soy solution feed tank can be re-filled with the batch of newly prepared soy solution from the soy solution preparation tank. A minimum level of soy solution in the soy solution feed tank may be set to start the supply with newly prepared soy solution to prevent that the soy solution feed tank is completely emptied. Hence, there enough time may be provided to pump the soy solution from the soy solution preparation tank to the soy solution feed tank without risking a disruption of the panel production due to running out of soy solution. The minimum soy solution level of the soy solution feed tank may depend on the desired flows and tank capacities used and may be about 5 to 40%, preferably about 10 to 30% and more preferably about 20% of the total storage volume of the tank. The present invention is of course not limited to the provision of only one soy solution feed tank but may also comprise a plurality of respective soy solution feed tanks.

### 4. DESCRIPTION OF THE FIGURES

In the following, specific embodiments of the present invention are briefly described with respect to the enclosed figures. It is noted that the figures only depict exemplary embodiments of the present invention and are provided for illustrative purposes only to enhance the understanding of the present invention, thus not delimiting the present invention to the depicted configurations.

FIG. 1 shows a schematic view of a panel manufacturing system according to an embodiment of the present invention, and

FIG. 2 shows a schematic workflow of a panel manufacturing method according to an embodiment of the present invention.

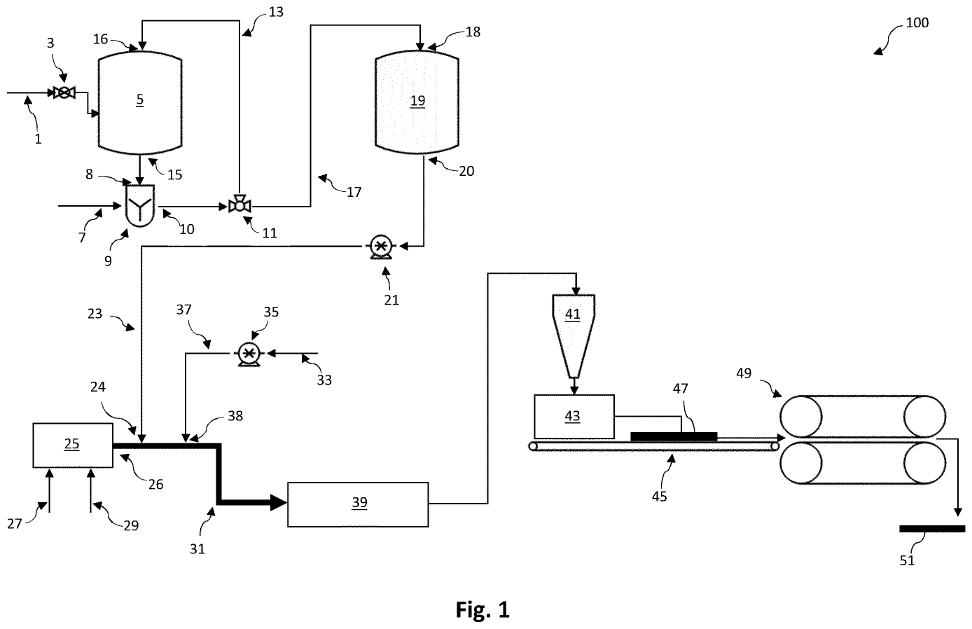

FIG. 1 shows a schematic view of a panel manufacturing system 100 according to one embodiment of the present invention comprising a water supply 1, which supplies water to a soy solution preparation tank 5 via a water regulation valve 3. The water is filled to the soy solution preparation tank 5 until a predetermined water level is reached. Then the water regulation valve 3 closes and the water is recirculated for 1 to 2 minutes (also referred to as pre-recirculation). The pre-recirculation allows to prevent a plugging of a mixer 9. During pre-recirculation, the water is guided from the soy solution preparation tank 5 via a soy solution preparation tank outlet 15 towards the mixer inlet 8. The water is then guided further through the mixer 9 and from the mixer outlet 10 towards a three-way valve 11. The three-way valve 11 is accordingly controlled to take a state where it is open towards the recirculation path 13 and closed towards a soy solution feed tank supply path 17. The water is accordingly recirculated back via the recirculation path 13 to a soy solution preparation tank inlet 16. After the pre-recirculation is completed, a predetermined amount of soy flour is supplied to the mixer 9 via the soy flour supply path 7 while the water is circulating. Hence, the soy flour is mixed with the circulating water to form a soy solution. The soy solution is continuously recirculated about 10 to 60 minutes to obtain a consistent mixture. During recirculation, additional soy flour is added and mixed. Thus, a predetermined amount of soy flour is continuously supplied to the recirculation soy solution until a suitable amount of soy solution is prepared in a sufficiently high soy concentration. The soy solution can be temporarily stored in the soy solution preparation tank 5. After the desired amount and concentration of soy solution is obtained, the three-way valve 11 is controlled to close towards the recirculation path 13 and to open towards the soy solution feed tank supply path 17. The soy solution is accordingly supplied to a soy solution feed tank 19 via a soy solution feed tank inlet 18.

After the soy solution has been transferred to the soy solution feed tank 19, the three-way valve 11 is closed again towards the soy solution feed tank supply path 17 and is opened again towards the recirculation path 13, such that a new batch of soy solution can be prepared and stored in the soy solution preparation tank 5. From the soy solution feed tank 19, the soy solution is continuously transferred via the soy solution feed tank outlet 20, a soy solution pump 21 and through a blow line soy solution supply path 23 to the soy solution port 24 of the high-pressure blow line 31. The soy solution is then injected to the high-pressure blow line 31 with a pressure of 0.4 to 0.6 MPa.

Once the soy solution feed tank 19 reaches a predetermined minimum level, the transfer of soy solution to the high-pressure blow line 31 is stopped and the soy solution feed tank 19 can be re-filled with a new batch of soy solution from the soy solution preparation tank 5. The soy solution feed tank 19 is provided with an internal agitator that maintains the soy solution homogenously while it is being transferred to the high-pressure blow line 31.

The panel manufacturing system 100 further comprises a wood refiner 25, which is supplied with wood chips via a wood chips supply path 27 and with hot pressurized steam at 0.8 MPa via a steam supply path 29. The wood refiner 25 is powered with 100 kW electricity per ton of chips and breaks up the wood chips in about 3 to 5 minutes into woods fibers with a temperature of 160° C. and a pressure of 0.6 MPa. The resulting wood fibers are accordingly supplied to the high-pressure blow line 31 via a wood fiber port 26 upstream of the soy solution port 24. PMDI resin is transferred via a resin supply path 33 and a resin pump 35 through a blow line resin supply path 37 to the high-pressure blow line 31. The resin is injected at the resin port 38 to the high-pressure blow line 31 with a pressure of 0.4 to 0.6 MPa downstream of the soy solution port 24.

The high-pressure blow line 31 operates with a pressure of 0.4 to 0.6 MPa and 150 to 165° C. The hot pressurized soy flour wood fiber resin mixture finally exits the high-pressure blow line 31 towards a dryer 39, wherein the mixture is pre-dried from a moisture content of about 70% to about 10% in about 5 to 6 seconds. The pre-dried soy flour wood fiber resin mixture is then transferred from the dryer 39 to a cyclone separator 41 to separate the solid contents of the pre-dried soy flour wood fiber resin mixture from the hot air stream in about 15 to 20 seconds. The thus separated pre-dried soy flour wood fiber resin mixture is accordingly supplied to a mat forming means 43, wherein the pre-dried soy flour wood fiber resin mixture is laid down on a continuous conveyor belt 45 to form a mat 47 of a defined thickness between 50 and 350 mm. The mat 47 is then transferred via the conveyor belt 45 to a continuous press 49, which suitably presses the mat into a wood composite panel 51.

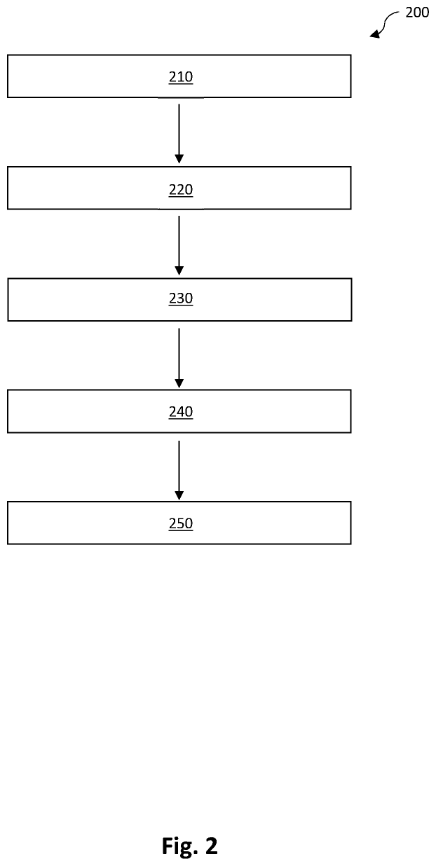

FIG. 2 shows a schematic workflow of a panel manufacturing method 200 according to one embodiment of the present invention comprising different manufacturing steps. In a first step 210 soy flour and water are provided and mixed in a weight ratio of 10 to 45% to form a respective soy solution. Subsequently, in a second step 220, the soy solution is introduced to a high-pressure blow line 31 containing wood fibers. Subsequently, in a third step 230, resin is introduced to the high-pressure blow line 31. The resin is introduced downstream of the location where of the soy solution introduction occurred. Hence a soy solution wood fiber resin mixture is formed. Subsequently, in a fourth step 240 the soy solution wood fiber resin mixture is pre-dried, thus forming a pre-dried soy flour wood fiber resin mixture. Finally, in a fifth step 250, the pre-dried soy flour wood fiber resin mixture is hot-pressed into a wood composite panel 51.

### 5. LIST OF REFERENCE SIGNS

1 Water supply
3 Water regulation valve
5 Soy solution preparation tank
7 Soy flour supply path
8 Mixer inlet
9 Mixer
10 Mixer outlet
11 Three-way valve
13 Recirculation path
15 Soy solution preparation tank outlet
16 Soy solution preparation tank inlet
17 Soy solution feed tank supply path
18 Soy solution feed tank inlet
19 Soy solution feed tank
20 Soy solution feed tank outlet
21 Soy solution pump
23 Blow line soy solution supply path
24 Soy solution port
25 Wood refiner
26 Wood fiber port
27 Wood chips supply path
29 Steam supply path
31 High-pressure blow line
33 Resin supply path
35 Resin pump
37 Blow line resin supply path
38 Resin port
39 Dryer
41 Cyclone separator
43 Mat forming means
45 Conveyor belt
47 Mat
49 Press
51 Panel
100 Panel manufacturing system
200 Panel manufacturing method
210 First manufacturing step
220 Second manufacturing step
230 Third manufacturing step
240 Fourth manufacturing step
250 Fifth manufacturing step

1. A method for manufacturing a wood composite panel, in particular an MDF-panel, comprising the following steps:
a. providing and mixing soy flour and water in a weight ratio of about 10 to 45% to form a soy solution;
b. introducing the soy solution to a high-pressure blow line containing wood fibers;
c. introducing resin to the high-pressure blow line to form a soy solution wood fiber resin mixture;
d. pre-drying the soy solution wood fiber resin mixture to form a pre-dried soy flour wood fiber resin mixture; and
e. hot-pressing the pre-dried soy flour wood fiber resin mixture into the wood composite panel.

2. The method according to claim 1, wherein soy flour and water are mixed in step a. in a weight ratio of about 12.5 to 35% and preferably in a weight ratio of about 15 to 30% to form a soy solution.

3. The method according to claim 1, wherein between steps d. and e., an additional step of forming the pre-dried soy flour wood fiber resin mixture into mats is provided, wherein the mats are then hot-pressed in the next step.

4. The method according to claim 1, wherein the mixing in step a. comprises a recirculation step, wherein the soy solution is recirculated for about 2 to 180 minutes, preferably about 5 to 120 minutes and most preferably about 10 to 60 minutes to obtain a consistent soy solution.

5. The method according to claim 1, the high-pressure blow line provides a pressure of about 0.2 to 0.8 MPa, preferably about 0.3 to 0.7 MPa and most preferably about 0.4 to 0.6 MPa.

6. The method according to claim 1, wherein the high-pressure blow line provides a temperature of about 100° C. to 200° C., preferably about 130° C. to 180° C. and most preferably about 150° C. to 165° C.

7. The method according to claim 1, wherein the resin is a synthetic resin, preferably a PMDI resin.

8. The method according to claim 1, wherein the soy solution wood resin mixture obtained in step c. has a moisture content of about 40 to 90%, preferably about 50 to 80% and most preferably about 70%.

9. The method according to claim 1, wherein the pre-dried soy flour wood fiber resin mixture obtained in step d. has a moisture content of about 5 to 30%, preferably about 7 to 20% and most preferably about 10%.

10. The method according to claim 4, wherein the recirculation step and the soy solution injection step are performed simultaneously.

11. A wood composite panel obtainable by the method according to claim 1, wherein the panel comprises at least about 0.1 to 3.0% by weight of soy, preferably about 0.2 to 1.2% by weight of soy and most preferably about 0.4 to 0.8% by weight of soy.

12. A system for manufacturing a wood composite panel, in particular an MDF-panel, wherein the system comprises:
a mixing means for mixing water with soy flour powder to form a soy solution,
a high-pressure blow line connected to the mixing means, comprising:
a wood fiber port for introducing wood fibers to the high-pressure blow line,
a soy solution port for introducing the soy solution to the high-pressure blow line, and
a resin port for introducing resin to the high-pressure blow line to form a soy solution wood fiber resin mixture,
wherein the system further comprises a dryer arranged downstream of the high-pressure blow line for pre-drying the soy solution wood resin mixture to obtain a pre-dried soy flour wood fiber resin mixture, and
a press for hot-pressing the pre-dried soy flour wood fiber resin mixture to form the wood composite panel.

13. The system according to claim 1, wherein the system further comprises a mat forming means for forming the pre-dried soy solution wood resin mixture into mats before pressing.

14. The system according to claim 1, wherein the mixing means comprises:
a soy solution preparation tank having an inlet and an outlet, and
a mixer, preferably a high shear mixer, comprising an inlet and an outlet,
wherein the mixer inlet is connected to the soy solution preparation tank outlet to receive water or soy solution from the soy solution preparation tank, and
wherein the mixer outlet is connected to the soy solution preparation tank inlet via a recirculation path to allow a recirculation of the water or soy solution.

15. The system according claim 1, wherein the system further comprises a soy solution feed tank, which is adapted to receive the soy solution from the soy solution preparation tank, and which is further adapted to transmit the soy solution to the high-pressure blow line, preferably via a pump arranged between the soy solution feed tank and the high-pressure blow line.
